(19) United States
(12) Patent Application Publication
(10) Pub. No.: US 2006/0041753 A1
(43) Pub. Date: Feb. 23, 2006

(54) Fingerprint extraction

(75) Inventor: Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/529,360

(22) PCT Filed: Aug. 11, 2003
(86) PCT No.: PCT/IB03/03658

§ 371 Date: Mar. 25, 2005

(30) Foreign Application Priority Data
Sep. 30, 2002 (EP) 02079072.1

(51) Int. Cl. H04L 9/00

(52) U.S. Cl. 713/176

(57) ABSTRACT

Fingerprints are bit strings extracted from a media signal (e.g. an audio or video clip) to identify said media signal. Typically, they are derived from a perceptual property of the signal, for example, the spectral energy distribution of an audio fragment or the luminance distribution of a video image. A method and arrangement for extracting a fingerprint is here disclosed which is robust with respect to shifts of the perceptual property. Such shifts occur, inter alia, when the fingerprint is derived from a logarithmically mapped spectral energy distribution of an audio signal and said audio signal is subjected to speed changes. According to the invention, the fingerprint is not derived from the perceptual property as such, but from its auto-correlation function.

### FIELD OF THE INVENTION

The invention relates to a method and arrangement for extracting a fingerprint from a media signal.

### BACKGROUND OF THE INVENTION

A fingerprint, also often referred to as signature or hash, is a sequence of bits that is derived from multimedia content, e.g. an audio song, an image, a video clip, etc. Multimedia fingerprints are used, inter alia, in the field of authentication where it is desired to verify whether received content is original or detect whether the content has been tampered with. Fingerprints are also used to identify media content. A service that is likely to become very popular in the near future is audio identification. A fingerprint being derived from an unknown piece of music is sent to a database where the title, artist and other metadata is looked up and returned to the consumer.

A known method of extracting a fingerprint from a media signal is disclosed in Applicant's International Patent Application WO 02/065782. A schematic diagram of this prior-art method is shown in FIG. 1. The media signal (here an audio song) is divided into overlapping frames (101). A spectral representation of each frame is obtained by performing a Fast Fourier Transform (102). The energy of the audio signal in 33 logarithmically spaced sub-bands is subsequently computed (103). The bands lie in the range of 300-2000 Hz which is perceptually the most relevant range. The 33 energy levels constitute a sequence of perceptual property samples of the respective audio signal frame. In order to be invariant with respect to the absolute loudness of the audio signal and to prevent a major single audio frequency from producing identical sequences for successive frames, a simple 2-dimensional filter (104) is applied to the spectrogram prior to obtaining 32 differential property samples. The sequence is subsequently converted into a bit string by an appropriate thresholding operation (105). More particularly, a sub-band in a particular frame is assigned a bit ‘1’ if the energy difference with its neighboring sub-band is larger than the energy difference with its neighboring sub-band in the previous frame. Otherwise, the fingerprint bit is ‘0’.

The known method produces a string of 32 bits for each audio frame (≈0.4 sec). The frames are preferably overlapping (e.g. by a factor of 31/32) so that the bit strings change slowly with time. This makes the fingerprint extraction invariant with respect to time shifting and frame boundary positioning. Typically, blocks of 256 overlapping frames, i.e. 256×32=8192 bits (≈3 sec of audio) are used to identify a song.

The prior-art fingerprint extraction method has turned out to be very robust against almost all commonly used audio processing steps such as MP3 encoding, sample rate conversion, D/A and A/D conversion, equalization. However, it is not very robust against speed changes. It is quite common for radio stations to speed up audio by a few percent. They supposedly do this for two reasons. First, the duration of songs is then shorter and therefore it enables them to broadcast more commercials. Secondly, the beat of the song is faster and listeners seem to prefer this. The speed changes typically lie between zero and four percent.

### OBJECT AND SUMMARY OF THE INVENTION

It is an object of the invention to provide an improved method and arrangement for extracting a fingerprint from a media signal.

To this end, the method according to the invention comprises the steps of deriving from said media signal a sequence of samples of a given perceptual property of the signal; subjecting the sequence of property samples to an auto-correlation function to obtain a sequence of auto-correlation values; comparing said auto-correlation values with respective thresholds; and representing the results of said comparisons by respective bits of the fingerprint.

The method according to the invention differs from the prior-art method in that the fingerprint bits are not derived from the perceptual property of the signal as such, but from the auto-correlation of said property. The invention is based on the recognition that a speed change of an audio signal causes energy levels in sub-bands to be shifted from one sub-band to another, and exploits the insight that the auto-correlation function is shift invariant.

The auto-correlation function is well-known in the continuous (time) domain. However, we are dealing here with a finite sequence of property values (e.g. energy levels). Therefore, in a practical embodiment of the method according to the invention, the desired auto-correlation is approximated by correlating a sub-sequence of property samples with the complete sequence of property samples.

The auto-correlation function is preferably computed from a statistically significant number of property samples, which is larger than the desired number of fingerprint bits. Down-sampling of the computed auto-correlation function is provided to obtain the desired number of auto-correlation values.

### BRIEF DESCRIPTION OF THE DRAWINGS

FIG. 1 shows schematically a prior-art arrangement for extracting a fingerprint from an audio signal.

FIG. 2 shows schematically an arrangement for extracting a fingerprint from an audio signal according to the invention.

### DESCRIPTION OF EMBODIMENTS

Speed changes of an audio signal cause misalignment in both the temporal and frequency domain. Considering time misalignment, an audio excerpt subjected to a speed change of, say, 2% causes the 250^{th} fingerprint of this excerpt to be extracted at the position of the 255^{th}fingerprint of the original excerpt. Fortunately, in order to be shift-invariant, the fingerprints are constructed in such a way that they possess correlation along the time-axis. Therefore, the BER (bit error rate) between the original excerpt and the same excerpt with a speed change does not increase dramatically due to the temporal misalignment.

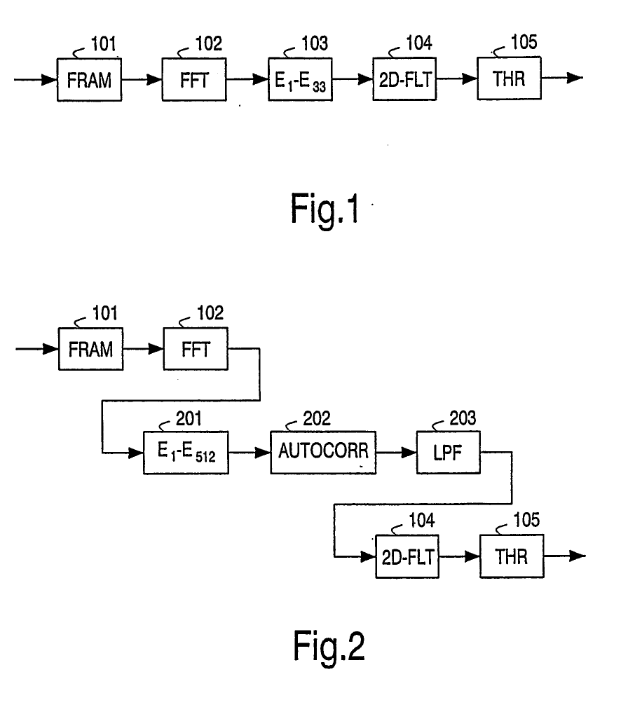

The main problem caused by large speed changes is therefore the frequency misalignment. In the prior arrangement, which is shown in FIG. 1, a 2% speedup will result in a scaling of the frequency axis of the spectrum that is obtained with the Fourier Transform. For example, a tone of 500 Hz then results in a tone of 510 Hz and a tone of 1000 Hz results in a tone of 1020 Hz. After calculating the spectrum, the energy in logarithmically spaced bands is determined. Since the bands are logarithmically spaced, the speed change results in a shift of energy from one band to the next. The more energy that shifts from one band to the next, the greater the probability that the extracted fingerprint bits are erroneous. This is due to the fact that the fingerprint bits are determined by energy differences of neighboring bands.

It has been proposed to use a brute force approach for identifying audio with large speed changes. The brute force approach consists of storing fingerprints extracted at multiple speeds in the database, or querying the database with fingerprints that are extracted at multiple speeds. The disadvantage of this method is that the search speed and/or storage requirements increase by a factor N, where N is the number of different speeds that is necessary for a certain application.

FIG. 2 shows an arrangement for extracting a fingerprint from an audio signal according to the invention. In the Figure, the same reference numerals are used for functions that are identical with or similar to the steps that have already been discussed with reference to FIG. 1. More particularly, the audio signal is divided into overlapping frames (101) and the spectrum of each frame is computed (102).

An auto-correlation step (202) is the fundamental step to achieve the better speed-change resilience. A speed change results in a shift of the computed energy vector. Auto-correlation has the property that it is shift-invariant. As is generally known, the auto-correlation ρ(x) of a continuous function f(t) is:

$$ρ ( x ) = {\int }_{- ∞}^{∞} f ( t ) f ( t + x ) ⅆ t$$

However, we are not dealing here with an infinite continuous function f(t) but a finite sequence of property samples (energies). In order to compute the auto-correlation from a statistically significant number of property samples, the energy of 512 sub-bands is computed (201) instead of 33. The bands are still logarithmic and still lie in the range of 300 to 2000 Hz. Thus the bands have a smaller width. The auto-correlation is approximated by correlating a sub-sequence of energies with the complete sequence. More specifically, the auto-correlation ρ[x] is calculated from the sub-band energy samples E(j) as follows:

$$ρ [ x ] = {\sum }_{j = 1}^{M} E ( K + j ) E ( x + j ) for x = 1 , 2 , … , N - M$$

where N denotes the length of the whole energy vector (here N=512), M denotes the length of the sub-sequence and K denotes the position where the sub-sequence starts in the complete sequence. Typical settings for M and K are 64 and 96, respectively. To increase robustness, the resulting auto-correlation values are optionally low-pass filtered (203). The low-pass filtered auto-correlation has 512−64=448 values, whereas 33 input values are required for the 2-dimensional filter (104) preceding the threshold operation (105). Therefore, the 448 auto-correlation values are down-sampled to 33 values in a down-sampler (204). The resulting fingerprint is a 32-bit string for each frame.

Although embodiments of the method and arrangement have been described with reference to audio fingerprint extraction, the invention is not restricted thereto. Applicant's International Patent Application WO 02/065782, already cited above, discloses a video fingerprint extracting method in which the fingerprint is derived from the mean luminance values of image blocks into which each image is divided. According to the invention, each image is now divided into a larger number of blocks, and a sub-set of the blocks (a “super-block”) is correlated with the whole image for a number of positions of said super-block. The obtained sequence of auto-correlation values is invariant to shifts of the video image. The sequence is optionally low-pass filtered and subsequently down-sampled.

The invention can be summarized as follows. Fingerprints are bit strings extracted from a media signal (e.g. an audio or video clip) to identify said media signal. Typically, they are derived from a perceptual property of the signal, for example, the spectral energy distribution of an audio fragment or the luminance distribution of a video image. A method and arrangement for extracting a fingerprint is here disclosed which is robust with respect to shifts of the perceptual property. Such shifts occur, inter alia, when the fingerprint is derived from a logarithmically mapped spectral energy distribution of an audio signal and said audio signal is subjected to speed changes. According to the invention, the fingerprint is not derived from the perceptual property as such, but from its auto-correlation function.

1. A method of extracting a fingerprint from a media signal, comprising the steps of extracting from said media signal a sequence of samples of a given perceptual property of the signal, and deriving from said sequence a binary sequence constituting said fingerprint, characterized in that the method comprises the steps of:
subjecting the sequence of property samples to an auto-correlation function (202) to obtain a sequence of auto-correlation values;
comparing (105) said auto-correlation values with respective thresholds; and
representing the results of said comparisons by respective bits of the fingerprint.

2. A method as claimed in claim 1, wherein said step of subjecting the sequence of property samples to an auto-correlation function comprises correlating a sub-sequence of property samples with the complete sequence of property samples.

3. A method as claimed in claim 1, wherein said step of subjecting the sequence of property samples to an auto-correlation function further includes down-sampling (204) the sequence of auto-correlation values to obtain a desired number of auto-correlation values.

4. A method as claimed in claim 1, wherein said step of deriving from said media signal a sequence of perceptual property values comprises dividing an audio signal into sub-bands and computing the energies of said audio sub-bands.

5. A method as claimed in claim 1, wherein said step of deriving from said media signal a sequence of perceptual properties comprises dividing an image into blocks and computing the luminances of said image blocks.

6. An apparatus for extracting a fingerprint from a media signal, comprising means for deriving from said media signal a sequence of samples of a given perceptual property of the signal, and means for deriving from said sequence a binary sequence constituting said fingerprint, characterized in that the apparatus comprises:
means for subjecting the sequence of property samples to an auto-correlation function to obtain a sequence of auto-correlation values;
means for comparing said auto-correlation values with respective thresholds; and
representing the results of said comparisons by respective bits of the fingerprint.

7. A computer program comprising instructions to cause a programmable device to perform the steps of:
deriving from a received media signal a sequence of samples of a given perceptual property of the signal;
subjecting the sequence of property samples to an auto-correlation function to obtain a sequence of auto-correlation values;
comparing said auto-correlation values with respective thresholds; and
representing the results of said comparisons by respective bits of a fingerprint.
